(19) United States
(12) Patent Application Publication
(10) Pub. No.: US 2015/0015514 A1
(43) Pub. Date: Jan. 15, 2015

(54) METHOD AND APPARATUS FOR GROUP COMMUNICATIONS

(71) Applicant: Samsung Electronics Co., Ltd., Gyeonggi-do (KR)

(72) Inventor: Minjae JUNG, Seoul (KR)

(73) Assignee: Samsung Electronics Co., Ltd.

(21) Appl. No.: 14/329,521

(22) Filed: Jul. 11, 2014

(30) Foreign Application Priority Data
Jul. 11, 2013 (KR) 10-2013-0081718

(51) Int. Cl. G06F 3/0488; H04L 12/18

(52) U.S. Cl. CPC G06F 3/0488; H04L 12/18
USPC 345/173

(57) ABSTRACT

Provided are a method and an apparatus for a group communication. The method includes displaying a group talk screen, detecting a touch event for starting the group communication in the group talk screen, executing a group communication mode according to the touch event, selecting at least one other user in response to a user input in the group communication mode, and executing a group communication with the selected other user in response to a release of the touch event.

### PRIORITY

This application claims priority under 35 U.S.C. §119(a) to a Korean Patent Application filed on Jul. 11, 2013 in the Korean Intellectual Property Office and assigned Serial No. 10-2013-0081718, the contents of which are incorporated herein by reference.

### BACKGROUND OF THE INVENTION

1. Field of the Invention

The present invention relates generally to a method and an apparatus for a group communication, and more particularly, to a method and an apparatus for performing a group communication with a second user according to a selection of a first user during group talking with a plurality of another users by using a messenger.

2. Description of the Related Art

Currently, portable terminals provide many services such as a Social Network Service (SNS), Smart Banking, and a Messenger. In particular, the Messenger can send and receive much more information such as voice, an image, and a video than a conventional text message used in a portable terminal.

However, as to group talking, the Messenger provides only an individual call function with each individual person who joins in talking, and does not provide a multi call function with a plurality of persons who join group talking at a time. Accordingly, such a communication method is inconvenient to users.

### SUMMARY OF THE INVENTION

The present invention has been made to address at least the above-mentioned problems and/or disadvantages and to provide at least the advantages described below. Accordingly, an aspect of the present invention is to provide a method and an apparatus for a group communication that can perform a group call with other users who join in a group talk.

Another aspect of the present invention is to provide a method and an apparatus for a group communication that can perform a selective group call with other users selected by user as well as a total group call during a group talk.

Another aspect of the present invention is to provide a method and an apparatus for a group communication that can perform a group talk without a screen change (e.g., a new talk screen) with other users selected by a user during a group talk.

In accordance with an aspect of the present invention, a method for a group communication includes displaying a group talk screen on a touch screen, detecting a touch event in the group talk screen for starting the group communication with a plurality of users, executing a group communication mode according to the touch event, selecting at least one other user of the plurality of users, in response to a user input in the group communication mode, and executing a group communication with the selected at least one other user in response to a release of the touch event.

In accordance with another aspect of the present invention, an apparatus for a group communication includes a display unit configured to display a group talk screen on a touch screen, a touch sensor configured to detect a touch event of a user in the group talk screen, and a controller configured to control to detect the touch event in the group talk screen for executing a group communication mode with a plurality of users, detect the touch event for selecting at least one other user of the plurality of users if the group communication mode is executed, and execute the group communication if the touch event for selecting the at least one other user is released.

### BRIEF DESCRIPTION OF THE DRAWINGS

The above and other aspects, features and advantages of the present invention will be more apparent from the following detailed description taken in conjunction with the accompanying drawings, in which:

FIG. 1 illustrates a configuration of a portable terminal according to an embodiment of the present invention;

FIGS. 2A to 2G illustrate an operation of a selective group call in a portable terminal according to an embodiment of the present invention;

FIGS. 3A to 3C illustrate an operation of a selective group talk in a portable terminal according to an embodiment of the present invention;

FIGS. 4A to 4D illustrate an operation of a total group call during a group talk in a portable terminal according to an embodiment of the present invention;

FIG. 5 illustrates a method of a group communication in a portable terminal according to an embodiment of the present invention; and

FIG. 6 illustrates a method of a group communication in a portable terminal according to an embodiment of the present invention in detail.

### DETAILED DESCRIPTION OF EMBODIMENTS OF THE INVENTION

Embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

Prior to a detailed description of the present invention, a portable terminal herein includes all devices that use an Application Processor (AP), a Graphic Processing Unit (GPU), and a Central Processing Unit (CPU) such as all information communication devices that support a function of the present invention, a multimedia device, and their application devices. For example, the portable terminal includes a Smart Phone, a Personal Digital Assistant (PDA), a Tablet Personal Computer (PC), and a Portable Multimedia Player (PMP).

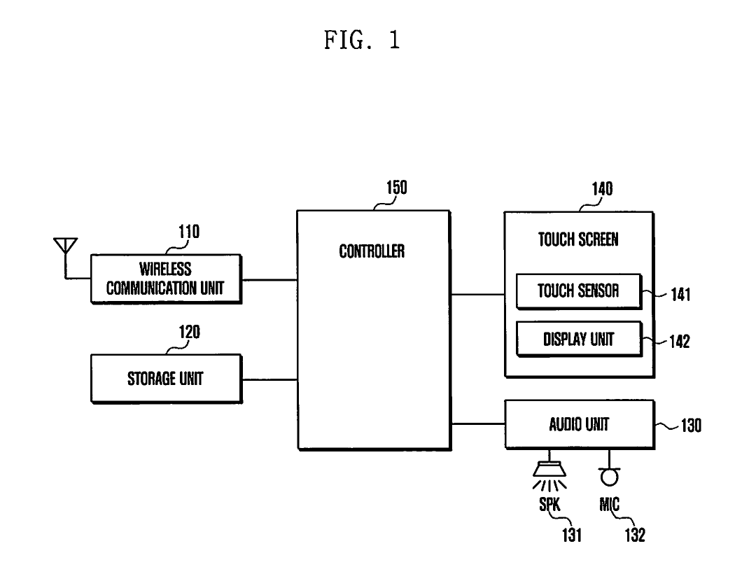

FIG. 1 illustrates a configuration of a portable terminal according to an embodiment of the present invention.

Referring to FIG. 1, the portable terminal includes a wireless communication unit 110, a storage unit 120, an audio unit 130, a touch screen 140, and a controller 150. The portable terminal of the present invention may include additional or fewer elements than those illustrated in FIG. 1.

For example, the portable terminal according to the present invention may include various sensors for detecting various gestures of a user (e.g., an infrared sensor, an illumination sensor, an image sensor, and a proximity sensor), a Wireless Local Area Network (WLAN) module for supporting a wireless internet, a short range communication module for supporting various short range communication technologies (e.g., Bluetooth®, Bluetooth® Low Energy (BLE,), and Near Field Communication (NFC)), and a broadcast reception module for receiving a broadcast signal from an external broadcast management server through a broadcast channel (e.g., a satellite broadcast channel, and a terrestrial broadcast channel).

The wireless communication unit 110 performs a communication of the portable terminal. The wireless communication unit 110 may form a communication channel with a supportable mobile communication network and perform communication such as voice, image, and data communication. The wireless communication unit 110 includes a radio frequency transmitting unit that up-converts and amplifies a frequency of a transmitted signal, and a radio frequency reception unit that low-noise amplifies and down-converts a received signal. The wireless communication unit 110 includes a mobile communication module (e.g., 3-Generation mobile communication module, a 3.5-Generation mobile communication module, or 4-Generation mobile communication module).

The storage unit 120 stores a program and a data required for the operation of the portable terminal, and may be divided into a program area and a data area. The program area stores a program that controls an overall operation of the portable terminal, an Operating System (OS) to boot the portable terminal, and an application program, for example. The data area stores, for example, data generated according to the use of portable terminal, images, and video.

In particular, the storage unit 120 of the present invention stores a telephone number by an input from a user. The storage unit 120 may temporarily store other user's telephone number selected by the user for a selective group communication. The storage unit 120 stores a voice message recorded by the user and data generated by the user (e.g., image and video).

An audio unit 130 performs a function of transmitting an audio signal input from the controller 150 to a speaker (SPK) 131, and transferring the audio signal received from a microphone (MIC) 132 such as voice to the controller 150. The audio unit 130 converts and outputs voice/sound data into an audible sound through the speaker 131 under the control of the controller 150 and converts the audio signal such as voice received from the microphone 132 into a digital signal to transmit to the controller 150.

The speaker 131 outputs the audio data received from the wireless communication unit 110 in a mode such as messenger, call, message, recording, voice recognition, broadcast reception, and a media content (music file, video file) play mode, or stored in the storage unit 120. The speaker 131 outputs a sound signal related with a function performed in a user device (e.g., messenger execution, talk reception, talk transmission, content image display, a content image-related function execution, call connection reception, call connection transmission, photographing, and media content file play).

The microphone 132 receives an external sound signal in, for example, a messenger, call, message, recording, and voice recognition mode, and processes as an electrical voice signal. In the call mode, the processed voice data may be converted into a transmittable form and be output to a mobile communication base station through the wireless communication unit 110. Various noise removing algorithms may be implemented in the microphone 132 so as to remove a noise generated in a process of receiving an external sound signal.

The touch screen 140 is an input-output means that performs an input function and an output function simultaneously, and includes a touch sensor 141 and a display unit 142. The touch screen 140 of the embodiment of the present invention displays a screen (e.g., a messenger execution screen, a call screen, and a gallery screen) according to an operation of the portable terminal through the display unit 142. The touch screen 140 transmits an input signal according to a touch event to the controller 150 if the touch event of the user by the touch sensor 141 is input while displaying a specific screen through the display unit 142. The controller 150 distinguishes the touch event, and controls the operations according to the touch event.

The touch sensor 141 detects a touch event of user (e.g., a long press, a tap, a drag, a sweep, a flick, and a multi-touch) contacting a surface of the touch screen 140. The touch sensor 141 detects a coordinate in which the touch event occurs when detecting the touch event of user on the surface of the touch screen 140, and transmits the detected coordinate to the controller 150. The controller 150 performs a function corresponding to the area in which the touch event occurs by a signal transmitted from the touch sensor 141.

The display unit 142 displays various screens according to a use of the portable terminal. For instance, a menu, input data, and other information are visually provided to the user. In particular, the display unit 142 of the present invention displays a group talk screen under control of the controller 150, and may be configured with a Liquid Crystal Display device (LCD) or an Organic Light Emitting Diode (OLED), for example.

The controller 150 controls the overall operation of the portable terminal and a signal flow between internal configurations of the portable terminal (a wireless communication unit 110, a storage unit 120, an audio unit 130, and a touch screen 140), processes data, and controls a power supply to the above described configurations from a battery.

In particular, the controller 150 of the present invention detects a touch event for an execution of messenger from the user, and controls the execution of messenger when detecting the touch event. When the messenger is executed, the controller 150 controls to display a group talk screen of a group selected by the user on the touch screen 140.

The controller 150 detects whether a touch event for starting a group communication (activating a group communication mode) occurs by the user when the group talk screen is displayed, and controls the execution of a group communication mode if the touch event occurs.

In this case, the touch event for the execution of the group communication mode includes a touch event (e.g., a long press, a double tap, and a drag) inputted on the displayed message written by the user on the group talk screen or a hover event.

The controller 150 selects at least one other user among the members of the group talk according to a user input inputted in the group communication mode. For instance, the user may input at least one other user selection (e.g., the selection of displayed message area written by other user) for a group communication by a multi-touch using other input means (e.g., a finger or a stylus) while maintaining the touch event.

Alternatively, the user may input a selection of another user by moving the touch event onto the displayed message area written by other user for the group communication to maintain for a certain time. The controller 150 then verifies a corresponding other user selected by the user input as a relevant person for the group communication. The controller 150 stores and manages information (e.g., contact information, etc.) related to at least one other user selected according to the user input for the group communication.

The controller 150 determines the execution of the group communication when the touch event is released on the group talk screen. For example, the controller 150 determines to execute the group communication with the selected other user when the touch event is released when at least one other user for the group communication is selected by the multi-touch while the touch event is maintained. Alternatively, the controller 150 determines to execute the group communication with the selected other user when the touch event is released after moving to the message area of a second user, and perform at least one operation activating the other user of a corresponding message area as other user for the group communication.

The controller 150 executes the group communication according to a pre-set group communication method, when it is decided that the group communication is executed in response to the release of the touch event of the user. For example, the controller 150 determines whether the group communication method is an automatic execution method or a manual execution method of displaying a menu pop-up. When the group communication method is the automatic execution method, the controller 150 controls a corresponding operation related to the group communication (e.g., a group call, group talking, a data transmission, or voice message transmission) set by the user.

For example, if the group communication set by the user is a group call, the controller 150 controls to automatically connect a group call with the other user selected by the user when the touch event is released and display a screen for the group call connection.

If the group communication set by the user is a group talk, the controller 150 controls a corresponding operation so that the group talk with the other user selected by the user may be performed when the touch event is released. According to an embodiment, the controller 150 controls to execute a selective group talk while maintaining a current group talk screen without changing the screen.

If the group communication set by the user is a data (e.g., an image and a video) transmission, when the touch event is released, the controller 150 controls a relevant operation to transmit data to the other user selected by the user. According to an embodiment, the controller 150 displays a gallery screen, and controls to transmit the data selected by the user to the selected other user as a group data.

If the group communication set by the user is voice message transmission, when the touch event is released, the controller 150 controls a relevant operation to transmit voice message to the other user selected by the user. According to an embodiment, the controller 150 executes voice input mode and display a relevant screen, records voice input from the user, and controls to transmit the recorded voice message to the selected other user.

If the group communication method is a manual execution method, the controller 150 displays a menu for a group communication execution in a form of a pop-up at a location where the touch event is released. When the touch event is detected when the menu for a group communication execution is displayed, the controller 150 controls to execute a menu of a location where the touch event is detected.

For instance, if the menu of a location where the touch event is detected is a group call, the controller 150 performs a connection of group call with the other users selected by the user, and controls to display a screen for group call connection. If the menu of a location where the touch event is detected is a group talk, the controller 150 controls to execute the group talk with the other users selected by the user, and controls to execute a selective group talk from an existing group talk screen without changing the screen. If the selected menu is a data (e.g., an image and a video) transmission, the controller 150 controls a relevant operation to transmit a corresponding data to the other user selected by the user.

The controller 150 displays a gallery screen to transmit data, and controls to transmit data selected according to the touch event of the user. If the selected menu is voice message transmission, the controller 150 controls a relevant operation to transmit the voice message to the other user selected by the user. The controller 150 displays a screen to record the voice message, and controls to transmit the recorded voice message.

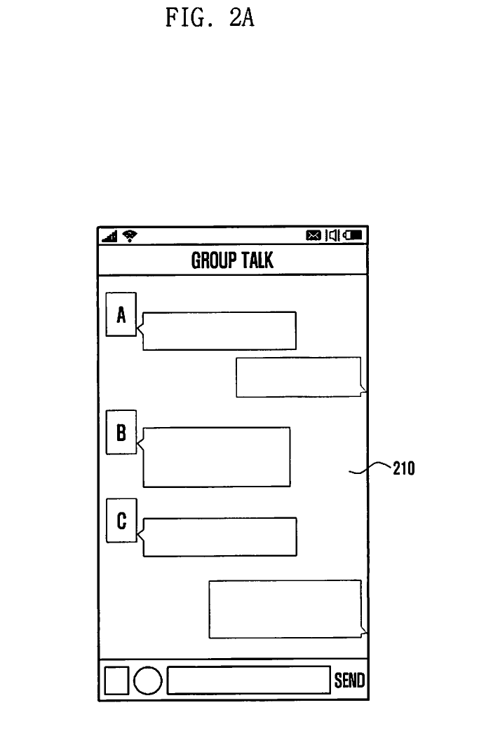

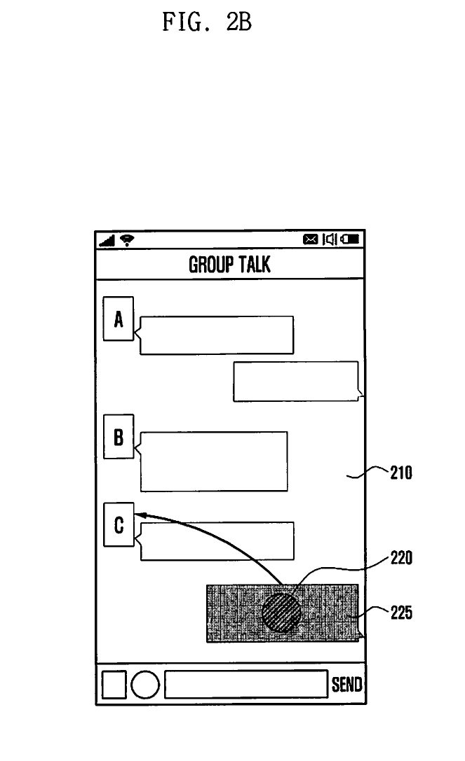

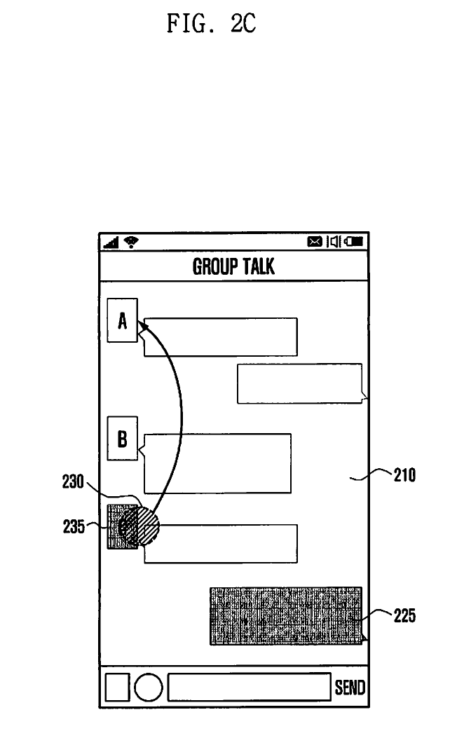

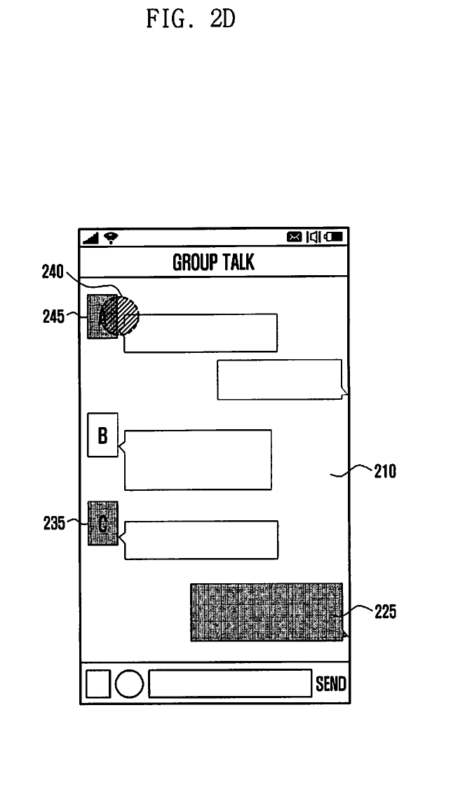

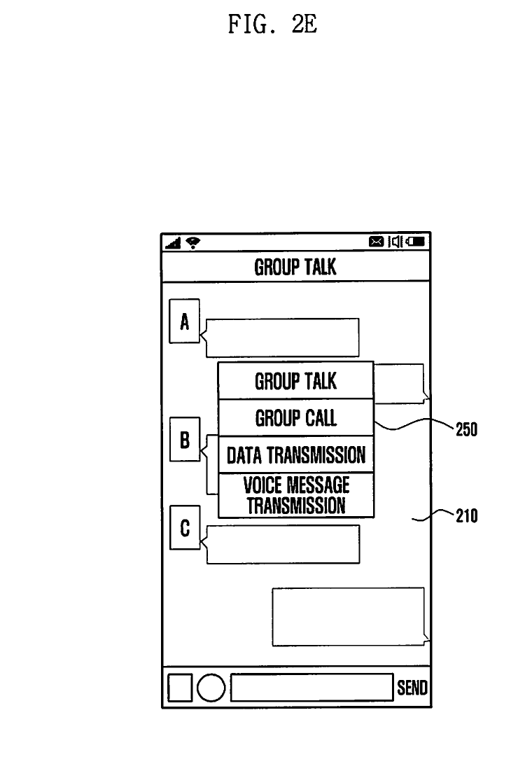

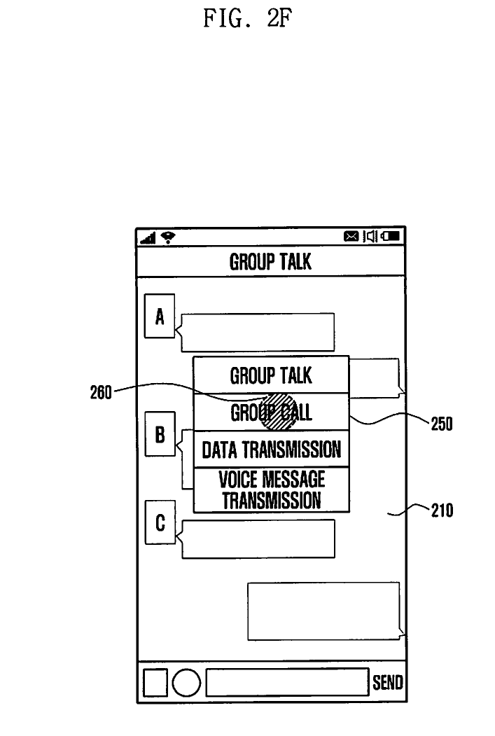

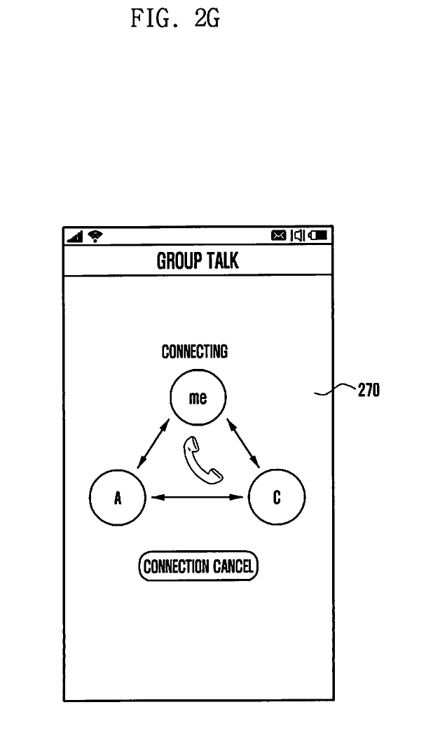

FIGS. 2A to 2G illustrate an operation of a selective group call in a portable terminal according to an embodiment of the present invention.

FIG. 2A illustrates a display of a group talk screen 210 in a messenger according to a request of user. For instance, the user selects a specific group for a group talk through the touch event, and the controller 150 displays the group talk screen 210 of a group according to the user's selection. In FIGS. 2A to 2G illustrate that the group talk screen 210 selected by the user is illustrated, but the present invention is not limited thereto. For example, the user may select a list (e.g., an address book, a text message, a call list, etc.) having contact information to execute the group call.

As shown in FIG. 2A, the user performs a selective group communication with a specific some other users among other users for a talk belonging to a current group when the group talk screen 210 is displayed. As shown in FIG. 2B, in order to perform the selective group communication, the user may inputs a touch event to a first area 220 in which a message written and entered by the user exists on the group talk screen 210. In the present invention, the touch event to start the group communication (i.e., activate a group communication mode) includes various input types that can be set by the user such as a long press input, a hovering input, a double tap input, and a multi-touch. In the present invention, it is illustrated that the group communication mode is activated by the touch event inputted by the long press input among the user inputs.

The controller 150 determines that a selective group communication mode is started when the touch event (e.g., a long press input) is detected in the first area 220. The controller 150 provides a visual effect for displaying that the selective group communication mode is activated when the user touch event for starting the selective group communication mode is detected. For instance, in reference numeral 225, the controller 150 highlights the first area 220, or differently displays a color of the first area 220, or display by reversing the first area 220. The user recognizes that the selective group communication mode is activated when the first area 220 is activated according to the touch event. The controller 150 may continuously maintain the group communication mode for the selective group communication mode while the user's touch event is maintained on the group talk screen 210.

As shown in FIG. 2B, in order to select a first other user (e.g., user C) for the selective group communication, the user moves (e.g., drag) the touch event (e.g., a long press) input to the first area 220 to a second area 230 in which a message written by the first other user (e.g., user C) is located.

When the touch event input in the first area 220 is maintained for a certain time after moving to the second area 230, the controller 150 determines that a corresponding interrupt is a selection input of another user for the group communication. For example, as shown in FIG. 2C, the user maintains the touch event for a certain time on the second area 230, and the controller 150 selects the other user (e.g., user C) corresponding to the second area 230 as a relevant person for the group communication when detecting that the touch event is maintained for a certain time on the second area 230. When a second user (e.g., user C) is selected as a relevant person for the group communication in response to the above mentioned user input, the controller 150 displays by applying various types of visual effects to feedback to the user. For instance, as shown in a reference numeral 235, the controller 150 highlights the second area 230, or differently displays a color of the second area 230, or display by reversing the second area 230.

As shown in FIG. 2C, the user may additionally select a second other user (e.g., user A) when the first other user (e.g., user C) is selected as the relevant person for the group communication. As described above, the user may continuously select the second other user (e.g., user A), and a third other user based on the method of selecting the first other user (e.g., user C) in the first area 220.

For instance, as shown in FIGS. 2C and 2D, the user selects the second other user (e.g., user A) as the relevant person for the group communication by moving the touch event, which is moved to the second area 230 and maintained for a certain time, to a third area 240 in which the second other user (e.g., user A) is located and maintaining for a certain time, so that the second other user (e.g., user A) of the third area 240 is selected as the relevant person for the group communication.

Therefore, the controller 150 considers a corresponding interrupt as the selection input of another user for the group communication when the touch event detected in the second area 230 is moved to the third region 240 and maintained for a certain time, and selects the second other user (e.g., user A) of the third area 240 as the relevant person for the group communication in response to the user input. As described above, when the second other user (e.g., user A) is selected as the relevant person for the group communication in response to the user input, the controller 150 may apply and display various types of visual effects 245 so as to feed back the above selection to the user. The above visual effect may be displayed in the same manner as the effect applied to the previously selected other user.

According to the embodiment of the present invention, a multi-touch method can be used as the user input for selecting the relevant person for the group communication in the group communication mode. For example, the user selects at least one other user for the group communication (e.g., select second area 230 and third area 240, etc.) by using other input means (e.g., a finger, a stylus, etc.) while maintaining the touch event inputted in the first area 220. The controller 150 then selects the relevant person for the group communication in response to the multi-touch input by the user in the group communication mode.

The user may generate an interrupt for the group communication when selecting all other users for the group communication in the group communication mode by operation of FIGS. 2A to 2D. For example, the user may generate a group communication execution interrupt by releasing the touch event on the third area 240. Alternatively, in the multi-touch method, the user may generate the group communication execution interrupt by releasing the touch event on the first area 220. When the user input for the group communication execution is detected, the controller 150 may automatically execute a pre-set group communication (e.g., a group call, a group talk, a group data transmission, or a group voice message transmission), or may execute the group communication according to user's menu selection after displaying a pop-up menu in which the user can select the group communication to be executed.

For example, as shown in FIG. 2E, the user releases the touch event on the group talk screen 210 so as to perform the selective group communication. When the user's touch event is released on the group talk screen 210, the controller 150 determines this as an input for executing the selective group communication. When the user's touch event is released, the controller 150 automatically executes the selective group communication or displays a menu 250 that can select a type of group communication, according to a preset group communication execution method. When the user's touch is released, the controller 150 can execute the group communication or display the menu 250.

FIG. 2E illustrates that a group communication menu 250 in which the user can select the group communication is provided. In the present invention, the group communication menu 250 for executing the selective group communication includes a menu such as a group talk, a group call, a data (e.g., an image or a video) transmission, and voice message transmission. The group communication may be variously implemented.

As shown in FIG. 2E, the user selects any one of the menu so as to execute the group communication desired by the user when the group communication menu 250 is displayed. For example, as shown in FIG. 2F, the user inputs the touch event (e.g., a tap event) to a group call area 260 in the group communication menu 250 in order to execute a group call with the other user (e.g., user C, user A) previously selected. If the touch event is performed on the group call area 260, the controller 150 executes the group call with reference to contact information of the previously selected other user (e.g., user C, user A), and controls a relevant screen display.

For example, as shown in FIG. 2G, the controller 150 displays a screen 270 indicating that the group call is being connected between the user (me), the first other user (e.g., user C), and the second other user (e.g., user A)). Accordingly, the user performs the selective group call with other users (e.g., user A and user C) selected by the user. Thus, the present invention can execute the selective group call with at least one other user selected by the user, instead of the entire group call with all other users who are joining in the group talk.

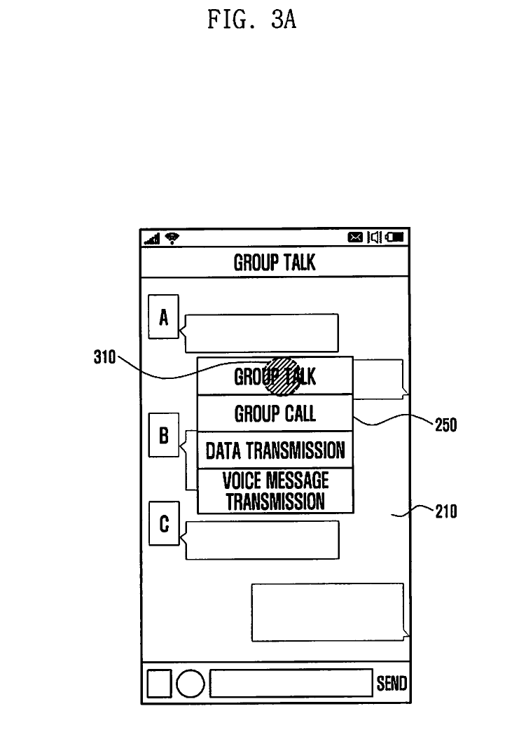

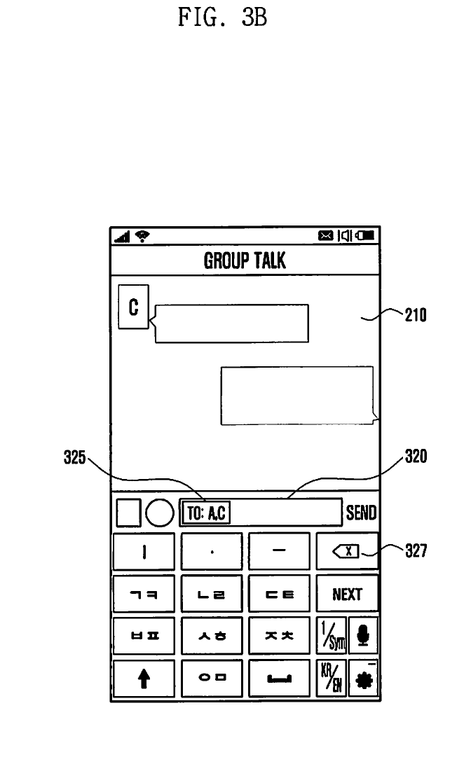

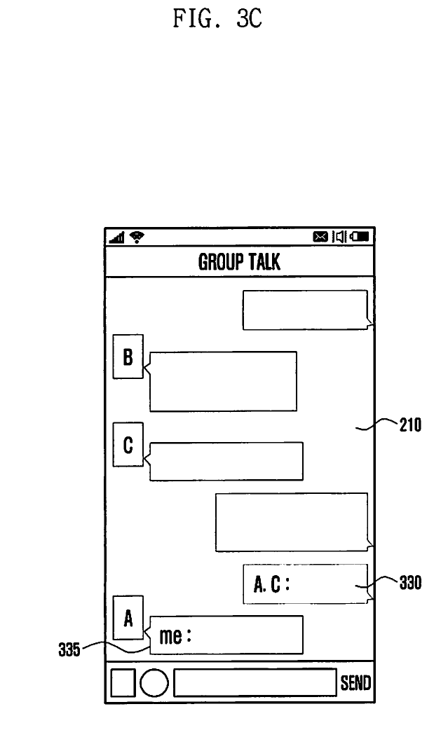

FIGS. 3A to 3C illustrate an operation of a selective group talk in a portable terminal according to an embodiment of the present invention.

As illustrated in FIG. 2E, FIG. 3A illustrates the group communication menu 250 to select the relevant person for the group communication by the user input in the group communication mode, and execute the selective group communication in response to the release of the touch event of the user when the relevant person for the group communication is selected.

As shown in FIG. 3A, the controller 150 displays the group communication menu 250 that can select a type of the group communication in response to the user's interrupt (e.g., a touch event release) for the execution of group communication. FIGS. 3A to 3C illustrate when the user attempts a group talk with a second user by using the group communication menu 250.

The user may input the touch event (e.g., a tap event) to a group talk area 310 in the group communications menu 250 as shown in FIG. 3A, so as to perform the group talk with the other user (e.g., user C, user A) previously selected. The controller 150 executes the group talk with the other user (e.g., user C, user A) who is previously selected when the touch event is performed on the group talk area 310. That is, when the touch event is performed on the group talk area 310, the controller 150 supports the selective group talk with a second user (e.g., user A, user C) previously selected among the members of the talk group.

For example, as shown in FIG. 3B, the controller 150 displays group talk target information 325 on a talk input window 320 so as to perform the group talk with other users (e.g., A and C) selected by the user. The controller 150 displays the group talk target information 325 such as “To: A, C” on the talk input window 320 so as to feedback to the other users A and C that the message according to the group talk is transmitted. The group talk target information 325 includes an item (e.g., an image, a text, or an emoticon) displayed on the talk input window 320 so as to support and feedback the message transmission for the group talk in the group to some other users selected by the user from among the current talk group (group talk screen 210).

When the user commands a transmission by inputting the message when the group talk target information 325 is displayed, the input message may be transmitted to a relevant person (i.e., the other users A and C selected by user) of the group talk target information 325.

When the user wants to perform a talk with all members of the current talk group, that is, a total group talk when the group talk target information 325 is displayed, the user transmits a message based on a general message input and transmission procedure after deleting the group talk target information 325 from the talk input window 320.

For instance, the user deletes the group talk target information 325 by inputting the touch event to a button (e.g., a cancel button) 327 that can cancel (delete) the message (text, etc.) input from the touch keypad, and, thereafter, returns to the total group talk by inputting and transmitting the message when the group talk target information 325 is deleted.

Referring again to FIG. 3B, the user inputs the message to be sent to the other user on the talk input window 320 displaying the group talk target information 325, and then commands a transmission. When the message transmission is requested after the group talk target information 325 is inputted, the controller 150 transmits a corresponding message to only the pre-selected users (user A and user C) of the group talk target information 325. In addition, as shown in FIG. 3C, the controller 150 displays a message 330 on the group talk screen 210.

The controller 150 displays the message 330 input by the selective group talk that includes recipient information (e.g., user A, user C) related to the selected relevant person, in order to distinguish the message according to the total group talk from the message according to the selective group talk. That is, according to the embodiment of the present invention, although the message input according to user's selective group talk is displayed on the current group talk screen 210 during the selective group talk, the message may be transmitted only to the other users (User A, User C) selected by the user.

The portable terminal of the other users (e.g., user A, user C), who received a message according to the selective group talk based on the above mentioned procedure among the members of the current talk group, distinguishes the message received according to the total group talk from the message received according to the selective group talk. As shown in FIG. 3C, the message received according to the selective group talk includes display of target designation information (e.g., me) for notifying that the message according to the selective group talk is transmitted by designating a user, by the other user(s).

During the selective group talk, the message transmitted according to the selective group talk of the other user(s) may be displayed on the current group talk screen 210, but the message may be transmitted and displayed only to the user.

In a distinction between the message according to the total group talk and the message according to the selective group talk, the portable terminal transmitting the message by the selective group talk includes a separator identifying the message according to the selective group talk in a header of the message and transmits the message.

The portable terminal receiving a corresponding message determines whether the message is a message of the total group talk or a message of the selective group talk with reference to the header of the message, and accordingly, may differently display the message. In the embodiment of the present invention, the method of distinguishing the message according to the total group talk from the message according to the selective group talk may be implemented in various manners.

In the present invention, the selective group talk may be performed on the existing group talk screen 210 without a screen change (e.g., a new talk screen). In addition, the selective group talk is executed with at least one other user not the total group talk, selected by the user with all other users who are joining in the group talk.

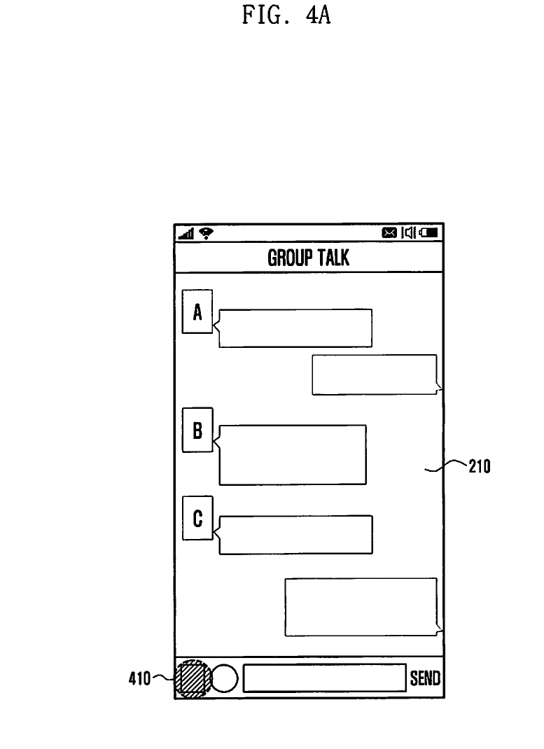

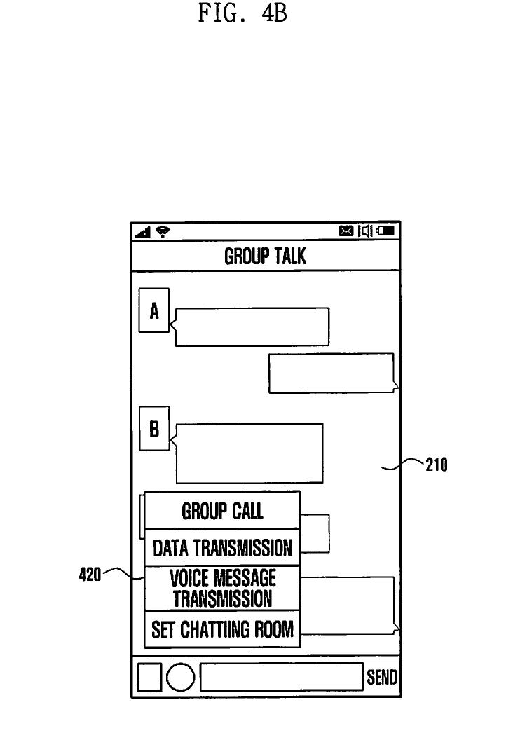

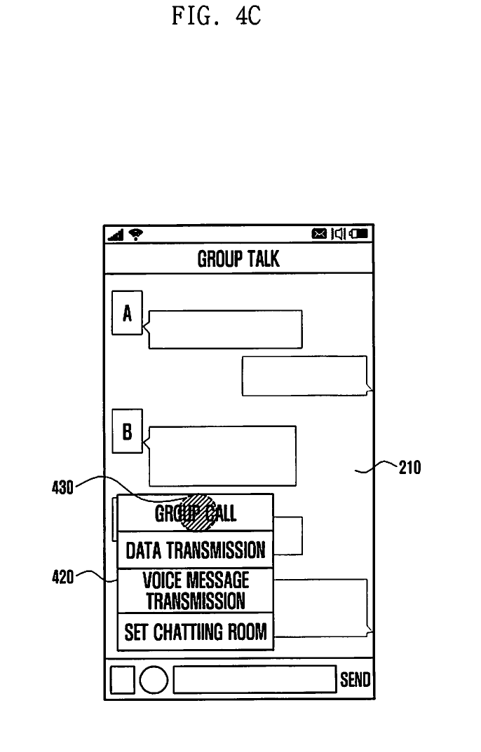

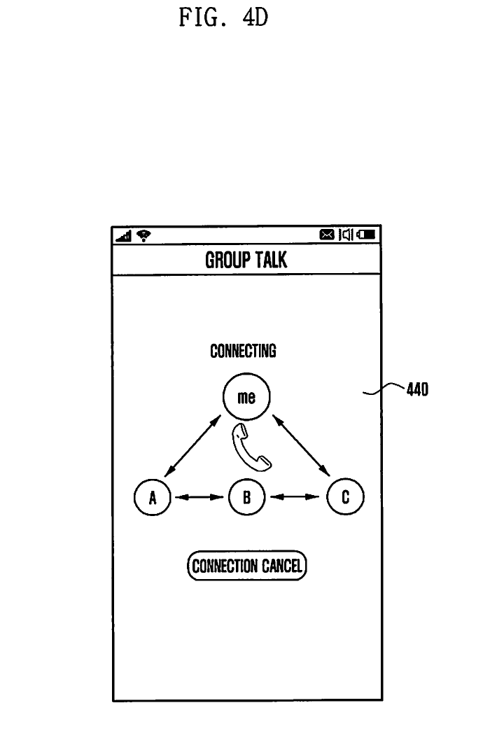

FIGS. 4A to 4D illustrate an operation of a total group call during a group talk in a portable terminal according to an embodiment of the present invention.

FIG. 4A illustrates when the group talk screen 210 is displayed in the messenger according to the request of the user. For instance, the user selects a specific group screen for group talk through the touch event, and the controller 150 displays the group talk screen 210 according to the selection of user. FIGS. 4A to 4D illustrate that the group talk screen 210 selected by the user is displayed, but it is not limited thereto. For example, the user may select a list (e.g., an address book, a text message, or a call list) having contact information so as to perform a group call.

As shown in FIG. 4A, the user inputs the touch event on a menu icon area 410 so as to perform the total group call. The controller 150 detects that the touch event is input on the menu icon area 410 by the user on the group talk screen 210.

The controller 150 displays a group communication menu 420 for a total group communication on the group talk screen 210 as shown in FIG. 4B, when the touch event is detected on the menu icon area 410. FIG. 4B illustrates when the group communication menu 420 that can select a group communication by user is provided. In the present invention, the group communication menu 420 for executing a total group communication includes a menu such as a group call, a data (e.g., an image or a video) transmission, or voice message transmission. The group communication may be variously implemented.

The user selects any one menu so as to execute a desired group communication when the group communication menu 420 is displayed, as shown in FIG. 4B. The controller 150 detects that the touch event for selecting a menu is performed on the group communication menu 420. For example, as shown in FIG. 4C, the user inputs the touch event (e.g., a tap event) to a group call area 430 in the total group communications menu 420 so as to perform the total group call. When the touch event is performed on the group call area 430, the controller 150 executes the group call with reference to the contact information of another user (e.g., user A, user B, user C) and controls a relevant screen display.

For instance, as shown in FIG. 4D, the controller 150 displays a screen 440 indicating that the group call is connected among a user (me), a first other user (e.g., user A), a second other user (e.g., user B), and a third other user (e.g., user C).

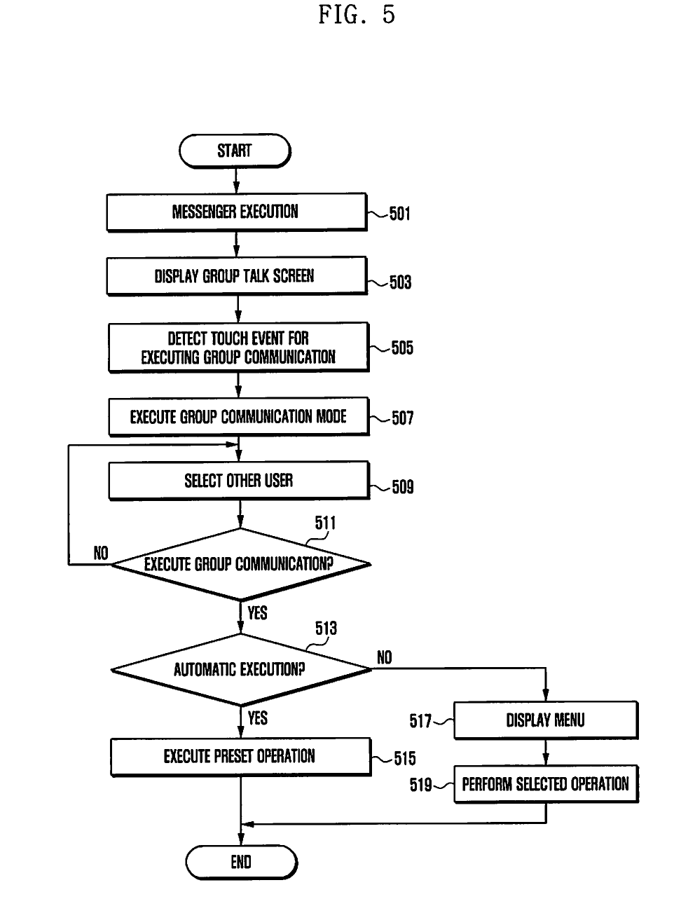

FIG. 5 illustrates a method of a group communication in a portable terminal according to an embodiment of the present invention.

Referring to FIG. 5, in step 501, the controller 150 controls the execution of a messenger corresponding to the selection of the user. In step 503, the controller 150 controls the display of group talk screen of the group selected from the user in the executed messenger. The present invention illustrates that the group talk screen is displayed after executing the messenger, but is not limited thereto. For instance, the user group may select a list (e.g., an address book, text messages, the call list, etc.) having contact information in order to perform the group call.

In step 505, the controller 150 detects whether a touch event for the selective group communication is inputted from the user when the group talk screen is displayed. For instance, the user may input the touch event to the input message written by the user himself on the group talk screen. In the present invention, the touch input for starting (i.e., activating a group communication mode) a group communication includes various input forms that can be set by the user such as a long press input, a hovering input, a double tap input, and a multi touch. Hereinafter, it is illustrated that the group communication mode is activated by the touch event that is performed by the long press input among user inputs.

In step 507, when the touch event of the user is detected at step 505, the controller 150 determines that this touch event is performed for the start of the selective group communication mode, and controls the start of the group communication mode. The controller 150 detects that the touch event for the selective group communication is continuously performed while the touch event of the user is maintained on the group talk screen 210. When the touch event of the user for the selective group communication mode is detected, the controller 150 provides a visual effect to display the activation of the selective group communication mode. The controller 150 continuously maintains the group communication mode for the selective group communication while the touch event of the user is maintained on the group talk screen 210.

In step 509, the controller 150 identifies the touch event for selecting other user from the user. For instance, when the touch event of the user is moved toward the other users' location on the group talk screen 210 and is maintained in order to select the other users (e.g., user C, user A), the controller 150 detects a corresponding interrupt as an input for the selection of the other user(s) for the group communication. A multi touch method can be used as a user input for selecting a relevant person for group communication in the group communication mode. For instance, when at least one other user (e.g., user A and/or user C) is selected by another input means such as a finger or a stylus when the touch event inputted to the message written by the user is maintained, the controller 150 detects a corresponding interrupt as an input for the selection of another user for the group communication.

In step 511, the controller 150 determines whether the touch event for executing the group communication is inputted. For example, when the touch event of the user is released on the group talk screen 210, the controller 150 determines that the group communication with the other user(s) (e.g., user A, user C) selected by the user from among the users who are joining in the group talk is executed.

In step 513, the controller 150 determines whether a preset group communication method is an automatic execution method or a manual execution method when the user input for the execution of group communication is detected.

In step 515, when the preset group communication method is the automatic execution method, the controller 150 controls to execute a specific group communication that is previously set by the user. For instance, when the group communication set to the automatic execution method is set to the group call on the group talk screen 210, the controller 150 operates automatically to perform the group call with the other user selected by the user when the touch event is released. In the present invention, the automatic execution operation may be set by the user with respect to the group call, the group talk, the data (e.g., an image or a video) transmission, or the voice message transmission, for example.

In step 517, when the preset group communication method is not the automatic execution method, that is, when the preset group communication method is the manual execution method, the controller 150 displays the group communication menu 250 for selection of group communication on the group talk screen 210. In the present invention, the group communication menu 250 includes a menu such as the group call, the group talk, the data (e.g., an image or a video) transmission, or the voice message transmission. The group communication can be variously implemented.

In step 519, when the touch event is detected in the group communication menu 250 in step 517, the controller 150 controls the operation corresponding to the menu in which the touch event is detected. For example, the controller 150 controls to perform the group talk with the other users selected by the user when the menu in which the touch event is detected is the group talk, and controls to perform the selective group talk on the existing group talk screen without changing a screen.

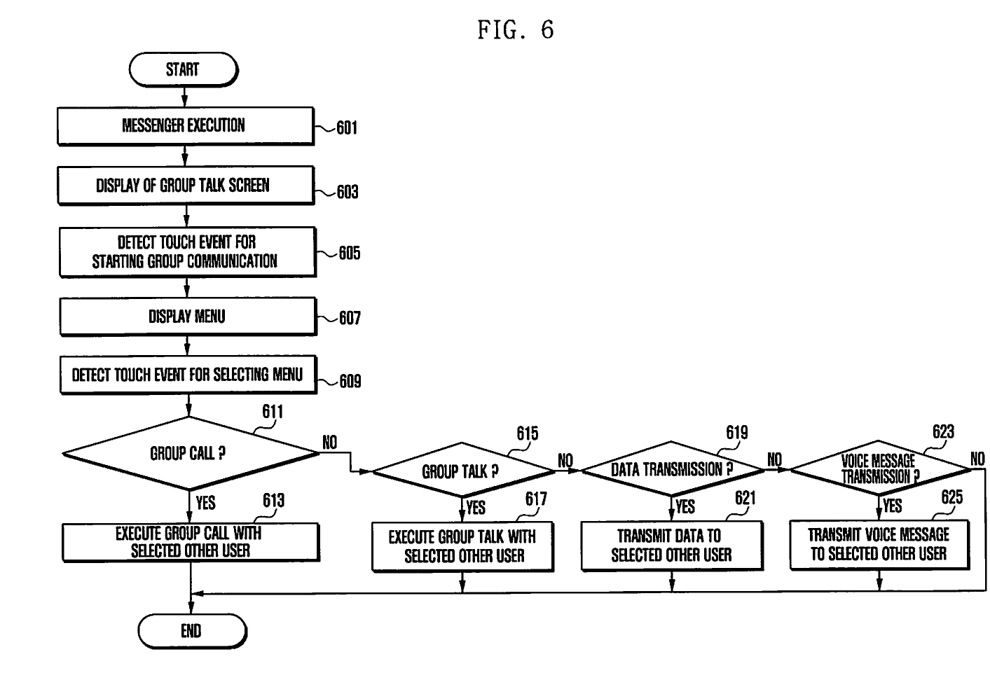

FIG. 6 illustrates a method of a group communication in a portable terminal according to an embodiment of the present invention.

Referring to FIG. 6, in step 601, the controller 150 controls the execution of messenger corresponding to the selection by the user. In step 603, the controller 150 controls the display of the group talk screen of a group selected by the user in the executed messenger. The present invention illustrates that the group talk screen is displayed after the execution of the messenger, but not limited thereto.

In step 605, the controller 150 controls the execution of the group communication mode when the touch event for the execution of the group communication is detected from the user. In addition, the controller 150 detects the touch event for selecting the other user(s) from the user, and determines that the execution of the group communication is intended when the touch event is released on the group talk screen 210.

In step 607, the controller 150 displays the group communication menu 250 when the touch event is released from the user on the group talk screen 210. In the present invention, the menu for the group communication 250 includes a menu such as group call, group talk, data transmission, and voice message transmission. The group communication may be variously implemented.

In step 609, the controller 150 detects the touch event for selecting a menu in the group communication menu 250. The controller 150 executes a corresponding menu when the touch event for selecting the menu is detected.

In step 611, the controller 150 determines whether the menu selected from the user is a group call. If the selected menu is the group call, the controller 150 connects the selective group call with the other users selected by the user in step 613. In addition, the controller 150 executes the group call with reference to the contact information of an other user(s) who is/are previously selected and controls a display of relevant screen. In the present invention, the selective group call is executed with at least one other user selected by the user, not the entire group call with all other users who are joining in the group talk.

When the selected menu is not the group call, the controller 150 determines whether the menu selected by the user is a group talk, in step 615. If the selected menu is the group talk, the controller 150 controls to perform the selective group talk with other users selected by the user, in step 617. In addition, the controller 150 executes the group talk with the other user previously selected and displays a relevant screen.

The controller 150 displays the message inputted by the user on the group talk screen 210, but the message may be transmitted only to the other user selected by the user. In addition, the controller 150 may also display the message written by other user on the group talk screen 210, but the message 335 written by the other user(s) may be displayed only to the user selected by the other user. Accordingly, in the present invention, the selective group talk may be performed on the existing group talk screen 210 without changing a screen (e.g., a new talk screen). The selective group talk is executed with at least one other user selected by the user, not the entire group talk with all other users who are joining in the group talk.

When the selected menu is not the group talk, the controller 150 determines whether the menu selected by the user is a data (e.g., an image or a video) transmission, in step 619. If the selected menu is the data transmission, the controller 150 controls to transmit data to the other users selected by the user, in step 621. In addition, for example, the controller 150 displays a gallery screen so as to transmit data, and controls to transmit data selected according to the touch event of the user to the other user selected by the user. The controller 150 performs the selective data transmission for at least one other user selected by the user, not the entire data transmission for all other users who are joining in the group talk.

When the selected menu is not the data transmission, the controller 150 determines whether the menu selected by the user is voice message transmission, in step 623. If the selected menu is the voice message transmission, the controller 150 controls to transmit the voice message to the other users selected by the user, in step 625. In the present invention, the controller 150 displays voice message-recording screen to transmit the voice message to the other user selected by the user, and control to transmit the recorded voice message. In addition, the controller 150 performs the selective voice message transmission for at least one other user selected by the user, not the entire voice message transmission for all other users who are joining in the group talk.

As described above, the present invention can select some other user from among a plurality of other users according to a touch event of user during a group talk with the plurality of users through a group talk screen, and can perform a selective group communication (a group call, a group data transmission, a group talk, or a group voice message transmission) with other users selected by user during a group talk through a group talk screen.

According to the present invention, a new group communication with at least one other user according to a user selection may be performed, while maintaining a group talk screen of a specific group.

In addition, the present invention may provide a group communication without changing a current screen of group talk when performing the group communication based on user input during a group talk.

Although embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A method for a group communication, the method comprising:
displaying a group talk screen on a touch screen;
detecting a touch event in the group talk screen for starting the group communication with a plurality of users;
executing a group communication mode according to the touch event;
selecting at least one other user of the plurality of users, in response to a user input in the group communication mode; and
executing a group communication with the selected at least one other user in response to a release of the touch event.

2. The method of claim 1, wherein the touch event for starting the group communication is inputted to a message written by one of the plurality of users in the group talk screen.

3. The method of claim 1, wherein selecting at least one other user comprises selecting at least one other user of a corresponding area of the touch screen as a relevant person for group communication when the touch event is moved to an area of a message written by the other user and is maintained for a time period.

4. The method of claim 1, wherein selecting at least one other user comprises selecting at least one other user of a corresponding area of the touch screen as a relevant person for group communication when an area of a specific message is selected by a multi-touch when the touch event is maintained for a time period.

5. The method of claim 1, wherein executing the group communication comprises determining whether an automatic execution method or a manual execution method is selected.

6. The method of claim 5, wherein executing the group communication comprises:
automatically executing the group communication previously set by the user, when determining that the automatic execution method is selected; and
displaying a group communication menu and executing the group communication selected by the user from the group communication menu, when determining that the manual execution method is selected.

7. The method of claim 1, wherein the group communication includes a group call, a group talk, a group data transmission, and a group voice message transmission.

8. The method of claim 1, wherein the group communication includes a selective group communication selected according to a user input or a total group communication for all of the plurality of users who are joining in the group communication.

9. The method of claim 1, wherein executing the group communication comprises executing a group communication without changing the group talk screen.

10. An apparatus for a group communication, the apparatus comprising:
a display unit configured to display a group talk screen on a touch screen;
a touch sensor configured to detect a touch event of a user in the group talk screen; and
a controller configured to control to detect the touch event in the group talk screen for executing a group communication mode with a plurality of users, detect the touch event for selecting at least one other user of the plurality of users if the group communication mode is executed, and execute the group communication if the touch event for selecting the at least one other user is released.

11. The apparatus of claim 10, wherein the controller is further configured to detect a touch event in a message written by the user in the group talk screen.

12. The apparatus of claim 10, wherein the controller is further configured to select at least one other user of a corresponding area of the touch screen as a relevant person for group communication when the touch event is moved to an area of message written by the other user and maintained for a certain time when the group communication mode is executed.

13. The apparatus of claim 10, wherein the controller is further configured to select the at least one other user of a corresponding area of the touch screen as a relevant person for group communication when an area of a specific message is selected by a multi-touch when the touch event is maintained for a time period.

14. The apparatus of claim 10, wherein the controller is further configured to control to execute a selective group communication with the at least one other user selected by the user or a total group communication with all of the plurality of users of the group communication.

15. The apparatus of claim 10, wherein the controller determines whether an automatic execution method or a manual execution method is selected when the group communication is executed.

16. The apparatus of claim 10, wherein the controller controls to execute a group communication without changing the group talk screen.
